(19) United States
(12) Patent Application Publication
(10) Pub. No.: US 2026/0012276 A1
(43) Pub. Date: Jan. 8, 2026

(54) TIME-SYNCHRONIZATION DEVICE, TIME-SYNCHRONIZATION SYSTEM, AND PROGRAM

(71) Applicant: Mitsubishi Electric Corporation, Tokyo (JP)

(72) Inventors: Lei LI, Tokyo (JP); Kaori IWATA, Tokyo (JP)

(73) Assignee: Mitsubishi Electric Corporation, Tokyo (JP)

(21) Appl. No.: 19/117,653

(22) PCT Filed: Apr. 4, 2023
(86) PCT No.: PCT/JP2023/013984

§ 371 Date: Apr. 2, 2025

(51) Int. Cl. H04J 3/06

(52) U.S. Cl. CPC H04J 3/0641; H04J 3/0667

(57) ABSTRACT

In a time-synchronization device, a grandmaster selector selects a first time-synchronization device as a grandmaster by performing a grandmaster arbitration process. A time synchronizer performs time synchronization as the grandmaster when the first time-synchronization device is selected as the grandmaster and performs time synchronization as a follower device when the first time-synchronization device is not selected as the grandmaster. An identification information storage stores identification information for identifying the first time-synchronization device selected as the grandmaster. In a time-synchronization device, when the first time-synchronization device is detached, the grandmaster selector selects a second time-synchronization device as a new grandmaster by performing the grandmaster arbitration process. When a new time-synchronization device is connected and the grandmaster selector identifies the new time-synchronization device as the detached first time-synchronization device based on the identification information, the grandmaster selector reselects the first time-synchronization device as the grandmaster without performing the grandmaster arbitration process.

### TECHNICAL FIELD

The present disclosure relates to a time-synchronization device, a time-synchronization system, a time-synchronization method, and a program.

### BACKGROUND ART

A time-synchronization system for synchronizing time uses a standard such as Institute of Electrical and Electronics Engineers (IEEE) 802.1AS or IEEE 1588 for master device systems that synchronize distributed clocks on a network including multiple devices. When the time-synchronization system uses such a standard, a best master clock algorithm (BMCA) is used to select a grandmaster (hereafter may also simply be referred to as a GM) that has the highest clock accuracy on the network through a grandmaster arbitration process (hereafter referred to as a GM arbitration process). The BMCA is an algorithm for selecting, from all the devices on the network, a device as a GM having the highest priority level indicated in BMCA priority information. Adjacent devices transmit and receive an Announce frame that is a frame for the GM arbitration process to and from each other to repeatedly compare BMCA priority information that is priority information for the GM arbitration process stored in each device with BMCA priority information acquired from other devices. The device with the highest priority level is selected as the GM and the devices other than the GM are to synchronize, as follower devices, time with the time distributed from the selected GM.

In the time-synchronization system, a device selected as the GM may be disconnected and detached from the network due to a trouble such as a malfunction, and may be reconnected to return to the network after the trouble is removed. With such standards described above, when the GM is detached, all the other follower devices are to perform the GM arbitration process again using the BMCA to select a new GM. When the previous GM returns, the returned previous GM, the new GM, and all the other follower devices are to perform the GM arbitration process again using the BMCA to determine whether the returned previous GM is to be reselected. When the GM arbitration process is performed, the devices cannot perform time synchronization with the GM. Thus, each device is to count the time. Typically, each device has different clock accuracy, and thus has time different from other devices. Thus, when a GM is detached and then returns in the time-synchronization system, the GM arbitration process is performed and may cause time differences among the devices.

In the time-synchronization system, in particular, the GM arbitration process using the BMCA takes a longer time as the number of devices on the network increases. Thus, time differences among the devices increase as the number of devices on the network increases. In the time-synchronization system, when the returned GM is reselected through the GM arbitration process using the BMCA and time synchronization between the returned previous GM and the other devices are restarted, large time differences may cause time discontinuity, or in other words, a time-synchronization abnormality.

Patent Literature 1 describes, as an example time-synchronization system that can reduce such a time-synchronization abnormality, a time-synchronization system in which a master node 1B of multiple master nodes can be recovered after being disconnected due to, for example, a failure. In Patent Literature 1, the master node 1B starts operating as a secondary master node when a master node 1A that functions as a primary master node is identified among other master nodes. In Patent Literature 1, the master node 1B switches the state of the port to the initial state as a grandmaster when the corrected local clock has a predetermined level of clock accuracy. In Patent Literature 1, the master node 1B determines, using the BMCA, whether to operate as a primary master node or a secondary master node when the local clock corrected by the master node 1B as the grandmaster clock has the predetermined level of accuracy.

Patent Literature 2 describes a communication system including communication devices that ignore the BMCA with a newly connected communication device having a high priority level unless the time difference with the newly connected communication device is less than the threshold.

### CITATION LIST

### Patent Literature

Patent Literature 1: Unexamined Japanese Patent Application Publication No. 2018-037885
Patent Literature 2: International Publication No. WO 2020/059139

### SUMMARY OF INVENTION

### Technical Problem

In the systems described in Patent Literatures 1 and 2, the GM arbitration process is to be performed using the BMCA to reselect the returned previous GM, possibly causing a time-synchronization abnormality. More specifically, in the time-synchronization system described in Patent Literature 1, when the recovered master node 1B is the disconnected primary master node, the master node 1B has a predetermined level of clock accuracy, and the BMCA determines the master node 1B as the primary master node, possibly causing a time-synchronization abnormality. In the communication system described in Patent Literature 2, when the newly connected communication device is the returned previous GM, the BMCA is performed when the time difference with the other devices is less than the threshold, possibly causing a time-synchronization abnormality.

Under such circumstances, an objective of the present disclosure is to reduce time-synchronization abnormalities resulting from the grandmaster arbitration process using the BMCA.

### Solution to Problem

To achieve the above objective, a time-synchronization device according to an aspect of the present disclosure is a time-synchronization device for performing time synchronization as a grandmaster or a follower device in a time-synchronization system for synchronizing time. The time-synchronization device includes a grandmaster selector to select the grandmaster by performing a grandmaster arbitration process for identifying, from a plurality of time-synchronization devices included in the time-synchronization system, one time-synchronization device corresponding to the grandmaster, a time synchronizer to perform time synchronization as the grandmaster when the time-synchronization device is selected as the grandmaster and to perform time synchronization as the follower device when the time-synchronization device is not selected as the grandmaster, and an identification information storage to store identification information for identifying the one time-synchronization device selected as the grandmaster. When the one time-synchronization device is disconnected and detached from the time-synchronization system, the grandmaster selector selects the grandmaster from the plurality of time-synchronization devices excluding the one time-synchronization device by performing the grandmaster arbitration process. When a new time-synchronization device is connected to the time-synchronization system and the grandmaster selector identifies the new time-synchronization device as the detached one time-synchronization device based on the identification information, the grandmaster selector selects the new time-synchronization device as the grandmaster without performing the grandmaster arbitration process.

### Advantageous Effects of Invention

The time-synchronization device according to the above aspect of the present disclosure reselects, when a new time-synchronization device connected to the time-synchronization system is the returned previous grandmaster, the new time-synchronization device as a grandmaster without performing the grandmaster arbitration process. The time-synchronization device according to the above aspect of the present disclosure can thus reduce time-synchronization abnormalities resulting from the grandmaster arbitration process using the BMCA more than the time-synchronization device that reselects the returned previous grandmaster after performing the grandmaster arbitration process.

### BRIEF DESCRIPTION OF DRAWINGS

FIG. 1 is a schematic diagram of an entire time-synchronization system according to an embodiment;

FIG. 2 is a functional block diagram of the time-synchronization system;

FIG. 3 is a block diagram of a time-synchronization device, illustrating the hardware configuration;

FIG. 4 is a diagram of an example of information stored in information storages;

FIG. 5 is a flowchart of a GM selection process at a startup of the system;

FIG. 6 is a flowchart of the GM selection process at detachment of the GM;

FIG. 7 is a flowchart of the GM selection process at new connection;

FIG. 8 is a timing chart of control at detachment and returning of the GM in a known time-synchronization system; and

FIG. 9 is a timing chart of control at detachment and returning of the GM in the time-synchronization system according to the present embodiment.

### DESCRIPTION OF EMBODIMENTS

A time-synchronization system, a time-synchronization device, a time-synchronization method, and a program according to one or more embodiments of the present disclosure are described in detail below with reference to the drawings. Like reference signs denote like or corresponding components in the drawings.

### Time-Synchronization System 1 According to Embodiment

A time-synchronization system 1 according to an embodiment of the present disclosure includes multiple time-synchronization devices (100 to 400) that each operate as a grandmaster (GM) or a follower device on a network, and causes each follower device to synchronize time with the GM. When the time-synchronization devices (100 to 400) synchronize time with one another, the clock included in each time-synchronization device (100 to 400) measures the same time. In other words, in the time-synchronization system 1, each of the time-synchronization devices (100 to 400) shares the same time, thus allowing time synchronization among the multiple time-synchronization devices (100 to 400).

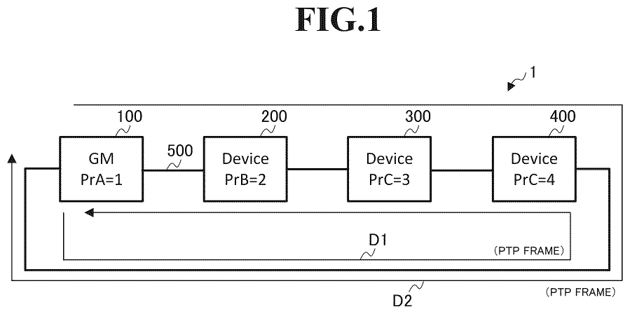

As illustrated in FIG. 1, a time-synchronization system 1 according to the present embodiment includes, as example time-synchronization devices, a first time-synchronization device 100, a second time-synchronization device 200, a third time-synchronization device 300, and a fourth time-synchronization device 400. Each of the time-synchronization devices 100 to 400 is a computer device such as a server computer or a personal computer and can transmit and receive information through a network 500.

In the present embodiment, the time-synchronization devices 100 to 400 are connected in a ring topology supporting multiple domains on the network 500, and perform time synchronization in both of a first domain D1 and a second domain D2 illustrated in FIG. 1. In the time-synchronization system 1, when one of the time-synchronization devices 100 to 400, for example, the first time-synchronization device 100, is disconnected from the network 500 due to a trouble such as an abnormality or disconnection of the line and cannot transmit and receive information, the other time-synchronization devices 200 to 400 connected to the network 500 can transmit and receive information to ensure communication redundancy.

The time-synchronization devices 100 to 400 are connected in a ring topology in the present embodiment, but may also be connected in another network topology such as a star topology or a mesh topology. As in the above embodiment, the time-synchronization devices 100 to 400 may support multiple domains to ensure communication redundancy and to easily continue time synchronization. However, the time-synchronization devices 100 to 400 may support a single domain without supporting multiple domains.

The time-synchronization system 1 according to the present embodiment causes, based on a precision time protocol (PTP) standard such as IEEE 802.1AS or IEEE 1588, the grandmaster and the follower devices to transmit and receive PTP frames such as Announce frames and Sync frames to perform time synchronization. At a startup of the system, or more specifically, when the time-synchronization devices 100 to 400 are powered on, the time-synchronization system 1 transmits and receives an Announce frame that is a frame for selecting a GM and selects a GM from the time-synchronization devices 100 to 400. The time-synchronization system 1 also causes the follower devices to transmit and receive PTP frames such as Sync frames, Delay_req frames, and Delay_resp frames that are frames for time synchronization to correct the time of the follower devices to be the time of the grandmaster for time synchronization between the grandmaster and the follower devices.

As illustrated in FIG. 1, in the time-synchronization system 1 according to the present embodiment, the PTP frames described above are transmitted and received among the time-synchronization devices 100 to 400 in both of the first domain D1 and the second domain D2. In the time-synchronization system 1, the first time-synchronization device 100 with the highest clock accuracy is selected as the GM, and the second time-synchronization device 200, the third time-synchronization device 300, and the fourth time-synchronization device 400 as the follower devices perform time synchronization with the first time-synchronization device 100 selected as the GM in both of the first domain D1 and the second domain D2.

### Time-Synchronization Devices 100 to 400 According to Embodiment

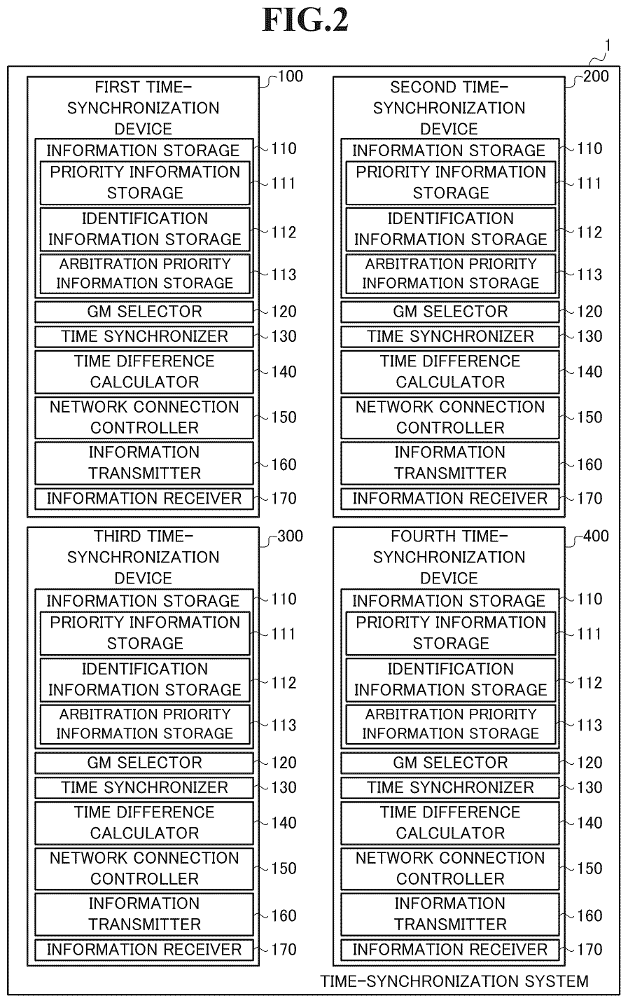

As illustrated in FIG. 2, the first time-synchronization device 100 includes an information storage 110 that stores information, a grandmaster selector 120 (hereafter referred to as a GM selector 120) that selects the GM, a time synchronizer 130 that performs time synchronization as the GM or the follower device, and a time difference calculator 140 that calculates a time difference. The first time-synchronization device 100 also includes a network connection controller 150 that controls connection to the network 500, an information transmitter 160 that transmits information, and an information receiver 170 that receives information. The information storage 110 includes a priority information storage 111 that stores priority information (described later), an identification information storage 112 that stores identification information (described later), and an arbitration priority information storage 113 that stores arbitration priority information (described later).

Similarly to the first time-synchronization device 100, the second time-synchronization device 200, the third time-synchronization device 300, and the fourth time-synchronization device 400 each include the information storage 110, the priority information storage 111, the identification information storage 112, the arbitration priority information storage 113, the GM selector 120, the time synchronizer 130, the time difference calculator 140, the network connection controller 150, the information transmitter 160, and the information receiver 170.

### Hardware Configuration of Time-Synchronization Devices 100 to 400 According to Embodiment

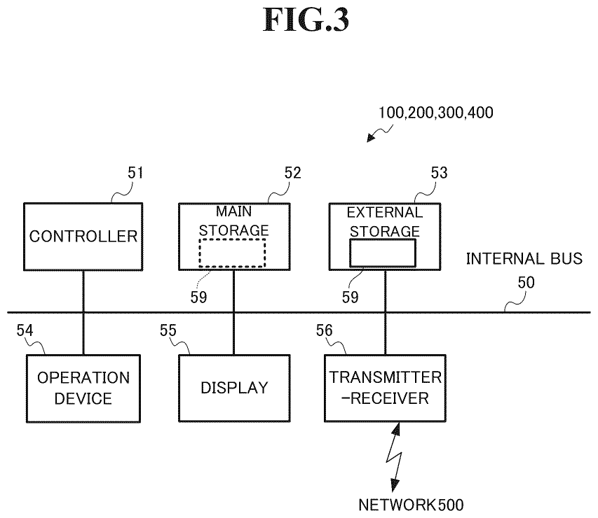

As illustrated in FIG. 3, the first time-synchronization device 100 includes, for example, a controller 51 that performs processes based on a control program 59. The controller 51 includes a central processing unit (CPU). The controller 51 functions as, for example, the GM selector 120, the time synchronizer 130, the time difference calculator 140, and the network connection controller 150 illustrated in FIG. 2 based on the control program 59.

Referring back to FIG. 3, the first time-synchronization device 100 includes a main storage 52 in which the control program 59 is to be loaded. The main storage 52 is used as a work area for the controller 51. The main storage 52 includes a random-access memory (RAM).

The first time-synchronization device 100 includes an external storage 53 that prestores the control program 59. The external storage 53 provides information stored in the program to the controller 51 as instructed by the controller 51, and stores information provided from the controller 51. The external storage 53 includes a non-transitory recording medium such as a read-only memory (ROM), a flash memory, a hard disk drive (HDD), or a solid-state drive (SSD). The external storage 53 functions as, for example, the information storage 110, the priority information storage 111, the identification information storage 112, and the arbitration priority information storage 113 illustrated in FIG. 2.

Referring back to FIG. 3, the first time-synchronization device 100 includes an operation device 54 operable by a user. Information input through the operation device 54 is provided to the controller 51. The operation device 54 includes information input components such as a keyboard, a mouse, and a touchscreen.

The first time-synchronization device 100 also includes a display 55 that displays information input through the operation device 54 and information output from the controller 51. The display 55 includes a display device such as a liquid crystal display (LCD) or an organic light-emitting diode (OLED) display.

The first time-synchronization device 100 also includes a transmitter-receiver 56 that transmits and receives information. The transmitter-receiver 56 includes an information communication device such as a communication network termination device or a wireless communication device connected to a network. The transmitter-receiver 56 functions as the information transmitter 160 and the information receiver 170 illustrated in FIG. 2.

Referring back to FIG. 3, in the first time-synchronization device 100, the main storage 52, the external storage 53, the operation device 54, the display 55, and the transmitter-receiver 56 are connected to the controller 51 with an internal bus 50.

The first time-synchronization device 100 implements the functions of the components 110 to 113 and 120 to 170 illustrated in FIG. 2 with the controller 51 using the main storage 52, the external storage 53, the operation device 54, the display 55, and the transmitter-receiver 56 as resources. The first time-synchronization device 100 causes, for example, the information storage 110 to store information, the priority information storage 111 to store priority information, the identification information storage 112 to store identification information, and the arbitration priority information storage 113 to store arbitration priority information. The first time-synchronization device 100 also causes, for example, the GM selector 120 to perform GM selection, the time synchronizer 130 to perform time synchronization, the time difference calculator 140 to perform time difference calculation, the network connection controller 150 to perform network connection control, the information transmitter 160 to perform information transmission, and the information receiver 170 to perform information reception.

The second time-synchronization device 200, the third time-synchronization device 300, and the fourth time-synchronization device 400 each have the same hardware configuration as the first time-synchronization device 100. More specifically, the same hardware configuration as described above applies to the second time-synchronization device 200 by replacing the first time-synchronization device 100 with the second time-synchronization device 200, to the third time-synchronization device 300 by replacing the first time-synchronization device 100 with the third time-synchronization device 300, and to the fourth time-synchronization device 400 by replacing the first time-synchronization device 100 with the fourth time-synchronization device 400. The hardware configurations of the second time-synchronization device 200, the third time-synchronization device 300, and the fourth time-synchronization device 400 are thus not described in detail to avoid redundancy.

### Details of Functional Configuration of Time-Synchronization Devices 100 to 400 According to Embodiment

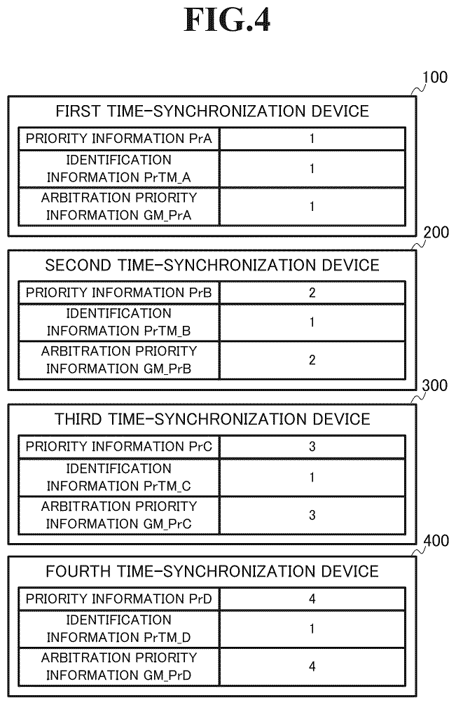

Referring back to FIG. 2, the priority information storage 111 stores priority information indicating a priority level prespecified to each of the time-synchronization devices 100 to 400 based on the clock accuracy. For example, the first time-synchronization device 100 has priority information PrA, the second time-synchronization device 200 has priority information PrB, the third time-synchronization device 300 has priority information PrC, and the fourth time-synchronization device 400 has priority information PrD. In this case, as illustrated in FIG. 4, the priority information storage 111 in the first time-synchronization device 100 stores PrA=1, the priority information storage 111 in the second time-synchronization device 200 stores PrB=2, the priority information storage 111 in the third time-synchronization device 300 stores PrC=3, and the priority information storage 111 in the fourth time-synchronization device 400 stores PrD=4. Smaller values of the priority information PrA, PrB, PrC, and PrD indicate higher priority levels for being the GM. Thus, the first time-synchronization device 100 has the highest priority level for being the GM, the second time-synchronization device 200 has the second-highest priority level, the third time-synchronization device 300 has the third-highest priority level, and the fourth time-synchronization device 400 has the lowest priority level.

Referring back to FIG. 2, each identification information storage 112 stores identification information for identifying the time-synchronization device selected as the GM. For example, the first time-synchronization device 100 has identification information PrTM_A, the second time-synchronization device 200 has identification information PrTM_B, the third time-synchronization device 300 has identification information PrTM_C, and the fourth time-synchronization device 400 has identification information PrTM_D. At the startup of the time-synchronization system 1, the identification information storage 112 in the first time-synchronization device 100 stores PrTM_A=1, the identification information storage 112 in the second time-synchronization device 200 stores PrTM_B=2, the identification information storage 112 in the third time-synchronization device 300 stores PrTM_C=3, and the identification information storage 112 in the fourth time-synchronization device 400 stores PrTM_D=4. In other words, at the startup of the time-synchronization system 1, the values of the identification information PrTM_A, PrTM_B, PrTM_C, and PrIM_D are the same as the respective values of the priority information PrA, PrB, PrC, and PrD.

When a GM selection process using a best master clock algorithm (BMCA) is performed at the startup of the system as an example of a GM arbitration process (described later) and the first time-synchronization device 100 is selected as the GM, the identification information storage 112 in the first time-synchronization device 100 stores PrTM_A=1, as illustrated in FIG. 4, the identification information storage 112 in the second time-synchronization device 200 stores PrTM_B=1, the identification information storage 112 in the third time-synchronization device 300 stores PrTM_C=1, and the identification information storage 112 in the fourth time-synchronization device 400 stores PrTM_D=1 as illustrated in FIG. 4. In other words, each value of the identification information PrTM_A, PrTM_B, PrTM_C, and PrTM_D stored in the corresponding identification information storage 112 in the time-synchronization devices 100 to 400 is the same as the value 1 of the priority information PrA on the first time-synchronization device 100 selected as the GM. Thus, PrTM_A=PrTM_B=PrTM_C=PrTM_D=PrA=1.

Referring back to FIG. 2, the arbitration priority information storage 113 stores arbitration priority information indicating the priority level of the corresponding time-synchronization device used to perform the GM arbitration process (described later). For example, the first time-synchronization device 100 has arbitration priority information GM_PrA, the second time-synchronization device 200 has arbitration priority information GM_PrB, the third time-synchronization device 300 has arbitration priority information GM_PrC, and the fourth time-synchronization device 400 has arbitration priority information GM_PrD. In this case, as illustrated in FIG. 4, the arbitration priority information storage 113 in the first time-synchronization device 100 stores GM_PrA=1, the arbitration priority information storage 113 in the second time-synchronization device 200 stores GM_PrB=2, the arbitration priority information storage 113 in the third time-synchronization device 300 stores GM_PrC=3, and the arbitration priority information storage 113 in the fourth time-synchronization device 400 stores GM_PrD=4. In other words, the values of the arbitration priority information GM_PrA, GM_PrB, GM_PrC, and GM_PrD are the same as the respective values of the priority information PrA, PrB, PrC, and PrD.

In the present embodiment, the values of the arbitration priority information GM_PrA, GM_PrB, GM_PrC, and GM_PrD are the same as the respective values of the priority information PrA, PrB, PrC, and PrD. However, the values may be different. For example, the values of the arbitration priority information GM_PrA, GM_PrB, GM_PrC, and GM_PrD stored in the respective arbitration priority information storages 113 in the time-synchronization devices 100 to 400 may simply be different from one another. More specifically, the values may indicate station numbers, Internet Protocol (IP) addresses, or clock identifications (IDs).

Referring back to FIG. 2, the GM selector 120 can perform the GM arbitration process for identifying, from the time-synchronization devices 100 to 400, one time-synchronization device (100) corresponding to the GM to select the GM. At the startup of the time-synchronization system 1, or in other words, when each of the time-synchronization devices 100 to 400 is powered on at the same time and a GM is yet to be selected, the GM selector 120 performs the GM selection process using the BMCA at the startup of the system to select a new GM. More specifically, the GM selector 120 causes the information transmitter 160 and the information receiver 170 to transmit and receive an Announce frame including the arbitration priority information (GM_PrA, GM_PrB, GM_PrC, or GM_PrD) on the corresponding time-synchronization device to and from adjacent time-synchronization devices (100 to 400). The GM selector 120 then repeatedly compares the values of the arbitration priority information (GM_PrA, GM_PrB, GM_PrC, and GM_PrD) and selects the first time-synchronization device 100 having the minimum value 1 as the GM. The GM selector 120 in each of the time-synchronization devices 200 to 400 updates the value of the identification information PrTM_B, PrTM_C, or PrTM_D stored in the identification information storage 112 in the second time-synchronization device 200, the third time-synchronization device 300, or the fourth time-synchronization device 400 to the same value as the identification information PrTM_A on the first time-synchronization device 100. Thus, each value of the identification information PrTM_B, PrTM_C, and PrTM_D on the second time-synchronization device 200, the third time-synchronization device 300, and the fourth time-synchronization device 400 is PrTM_B=PrTM_C=PrTM_D=PrTM_A=1.

When the first time-synchronization device 100 as the GM is disconnected and detached from the network 500 due to a trouble such as an abnormality or disconnection of the line, the GM selectors 120 perform the GM selection process using the BMCA at disconnection of the GM to select a new GM from the time-synchronization devices 200 to 400 excluding the first time-synchronization device 100. More specifically, the GM selector 120 in each of the time-synchronization devices 200 to 400 causes the information transmitter 160 and the information receiver 170 to transmit and receive an Announce frame including the arbitration priority information (GM_PrB, GM_PrC, or GM_PrD) on the corresponding time-synchronization device to and from adjacent time-synchronization devices (200 to 400). The GM selector 120 in each of the time-synchronization devices 200 to 400 then repeatedly compares the values of the arbitration priority information (GM_PrB, GM_PrC, and GM_PrD) to select the second time-synchronization device 200 having the minimum value 2 as a new GM. The GM selector 120 in each of the time-synchronization devices 200 to 400 does not update the value of the identification information PrTM_B, PrTM_C, or PrTM_D in the identification information storage 112 in each of the time-synchronization devices 200 to 400. More specifically, the value of the identification information PrTM_B, PrTM_C, or PrTM_D on each of the time-synchronization devices 200 to 400 remains PrTM_B=PrTM_C=PrTM_D=1 after the second time-synchronization device 200 is selected as the new GM.

When a new time-synchronization device is connected to the network 500 while the second time-synchronization device 200 is performing time synchronization as the new GM and the GM selectors 120 identify, based on the identification information, the new time-synchronization device as the detached first time-synchronization device 100, the GM selectors 120 select the first time-synchronization device 100 as a GM without performing the GM arbitration process using the BMCA. More specifically, when a new time-synchronization device is connected to the network 500, the network connection controller 150 in the new time-synchronization device causes the information transmitter 160 to transmit an Announce frame including identification information to adjacent time-synchronization devices (200 to 400). When the new time-synchronization device is the first time-synchronization device 100, the GM selector 120 in each of the time-synchronization devices 200 to 400 causes the information receiver 170 to receive an Announce frame including the identification information PrTM_A on the first time-synchronization device 100, and determines that a new time-synchronization device is connected to the network 500. When the value of the identification information PrTM_A included in the received Announce frame is the same as the value of the identification information PrTM_B, PrTM_C, and PrTM_D stored in the identification information storage 112 in each of the time-synchronization devices 200 to 400, the GM selector 120 in each of the time-synchronization devices 200 to 400 reselects the first time-synchronization device 100 as a GM without performing the GM arbitration process. The GM selector 120 in each of the time-synchronization devices 200 to 400 then notifies the first time-synchronization device 100 that the first time-synchronization device 100 is to be connected to the network 500 as a new GM, and transmits, to the second time-synchronization device 200 that is the current GM, a PTP frame transmission restart notification indicating that the first time-synchronization device 100 is to be connected to the network 500 as a new GM.

The GM selectors 120 do not select a new GM when a new time-synchronization device is connected to the network 500 while the second time-synchronization device 200 is performing time synchronization as the new GM and the GM selectors 120 identify, based on the identification information, that the new time-synchronization device is not the detached first time-synchronization device 100. More specifically, the GM selector 120 in each of the time-synchronization devices 200 to 400 does not select a new GM when the value of the identification information included in the received Announce frame is different from the values of the identification information PrTM_B, PrTM_C, and PrTM_D stored in the identification information storages 112 in the time-synchronization devices 200 to 400. Thus, the second time-synchronization device 200 continues to perform time synchronization as the GM.

When the second time-synchronization device 200 continues to perform time synchronization as the GM and the value of the identification information included in the received Announce frame is greater than the value of the identification information PrTM_B, PrTM_C, or PrTM_D stored in the identification information storage 112 in each of the time-synchronization devices 200 to 400, the network connection controller 150 in each of the time-synchronization devices 200 to 400 starts transmission and reception of information to and from the new time-synchronization device after time synchronization is performed between the second time-synchronization device 200 as the current GM and the new time-synchronization device. Thus, the new time-synchronization device can perform time synchronization as a follower device in the time-synchronization system 1.

When the second time-synchronization device 200 continues to perform time synchronization as the GM and the value of the identification information included in the received Announce frame is less than the value of the identification information PrTM_B, PrTM_C, or PrTM_D stored in the identification information storage 112 in each of the time-synchronization devices 200 to 400, the network connection controller 150 in each of the time-synchronization devices 200 to 400 does not start transmission and reception of information to and from the new time-synchronization device and causes the network connection controller 150 in the new time-synchronization device to be disconnected from the network 500. Thus, the new time-synchronization device does not perform time synchronization as a follower device in the time-synchronization system 1.

The time difference calculator 140 compares the time of the current GM with the time of the corresponding time-synchronization device to calculate the time difference. More specifically, the time difference calculator 140 causes the information transmitter 160 and the information receiver 170 to transmit and receive PTP frames such as Sync frames, Delay_req frames, and_Delay_resp frames to and from adjacent time-synchronization devices (100 to 400) and calculates the time difference.

The time difference calculator 140 calculates, for example, the time difference when the time synchronizer 130 performs time synchronization as a follower device. When, for example, the first time-synchronization device 100 is reconnected to the network 500 while the second time-synchronization device 200 is performing time synchronization as the new GM, the time difference calculator 140 in the first time-synchronization device 100 calculates, before performing time synchronization as a new GM, a time difference between the time of the second time-synchronization device 200 and the time of the first time-synchronization device 100 to determine whether to perform time synchronization with the second time-synchronization device 200.

When selected as a GM, the time-synchronization device as a GM causes the time synchronizer 130 to perform time synchronization. When not selected as a GM, the time-synchronization device as a follower device causes the time synchronizer 130 to perform time synchronization. For example, when a time-synchronization device as a follower device causes the time synchronizer 130 to perform time synchronization, the time synchronizer 130 corrects the time of the corresponding time-synchronization device using the time difference calculated by the time difference calculator 140 to synchronize time with the GM.

While the second time-synchronization device 200 is performing time synchronization as the new GM, the first time-synchronization device 100 may be reconnected and selected as a new GM. In this case, when the calculated time difference is less than or equal to 30 seconds being an example of a predetermined threshold, the first time-synchronization device 100 as a new GM causes the time synchronizer 130 to perform time synchronization without performing time synchronization with the second time-synchronization device 200. Thus, the other time-synchronization devices 200 and 300 that are follower devices cause the respective time synchronizers 130 to perform time synchronization with the first time-synchronization device 100 that has not performed time synchronization after being connected to the network 500. In this case, when the calculated time difference is greater than 30 seconds being an example of the threshold, the first time-synchronization device 100 as a new GM causes the time synchronizer 130 to perform time synchronization after performing time synchronization with the second time-synchronization device 200. Thus, the other time-synchronization devices 200 and 300 that are follower devices cause the respective time synchronizers 130 to perform time synchronization with the first time-synchronization device 100 that has performed time synchronization after being connected to the network 500.

### Flowchart of GM Selection Process at Startup of System According to Present Embodiment

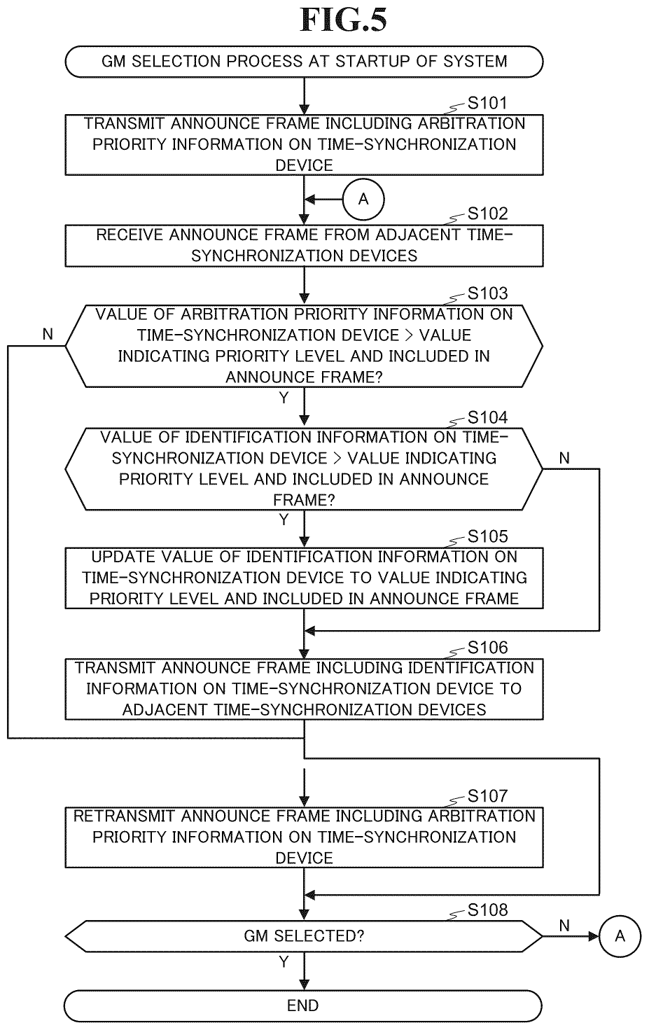

The operation of each of the time-synchronization devices 100 to 400 to select a GM at the startup of the time-synchronization system 1 is now described with reference to the flowchart illustrated in FIG. 5. When powered on, each of the time-synchronization devices 100 to 400 starts performing the GM selection process at the startup of the system illustrated in FIG. 5. As illustrated in FIG. 5, the GM selector 120 first causes the information transmitter 160 to transmit an Announce frame including arbitration priority information (GM_PrA, GM_PrB, GM_PrC, or GM_PrD) on the corresponding time-synchronization device to adjacent time-synchronization devices (100 to 400) (step S101) and causes the information receiver 170 to receive an Announce frame from the adjacent time-synchronization devices (100 to 400) (step S102).

After the Announce frame is received, the GM selector 120 determines whether the value of the arbitration priority information (GM_PrA, GM_PrB, GM_PrC, or GM_PrD) on the corresponding time-synchronization device is greater than the value indicating the priority level and included in the received Announce frame (step S103). When the value of the arbitration priority information (GM_PrA, GM_PrB, GM_PrC, or GM_PrD) on the corresponding time-synchronization device is greater (Yes in step S103), the GM selector 120 determines that the corresponding time-synchronization device is a follower device, and determines whether the value of the identification information (PrTM_A, PrTM_B, PrTM_C, or PrTM_D) on the corresponding time-synchronization device is greater than the value indicating the priority level and included in the received Announce frame (step S104).

When the value of the identification information (PrTM_A, PrTM_B, PrTM_C, or PrTM_D) on the corresponding time-synchronization device is greater than the value indicating the priority level and included in the received Announce frame (Yes in step S104), the GM selector 120 updates the value of the identification information (PrTM_A, PrTM_B, PrTM_C, or PrTM_D) on the corresponding time-synchronization device to the value indicating the priority level and included in the received Announce frame (step S105), and causes the information transmitter 160 to transmit an Announce frame including the value of the identification information (PrTM_A, PrTM_B, PrTM_C, or PrTM_D) on the corresponding time-synchronization device to adjacent time-synchronization devices (100 to 400) (step S106). When the value of the identification information (PrTM_A, PrTM_B, PrTM_C, or PrTM_D) on the corresponding time-synchronization device is less than the value indicating the priority level and included in the received Announce frame (No in step S104), the GM selector 120 performs the processing in step S106 without updating the value of the identification information (PrTM_A, PrTM_B, PrTM_C, or PrTM_D) on the corresponding time-synchronization device and transmits an Announce frame.

When the value of the arbitration priority information (GM_PrA, GM_PrB, GM_PrC, or GM_PrD) on the corresponding time-synchronization device is less than or equal to the value indicating the priority level and included in the received Announce frame (No in step S103), the GM selector 120 determines that the corresponding time-synchronization device may be a GM and does not update the value of the identification information (PrTM_B, PrTM_C, PrTM_D, or PrTM_A) on the corresponding time-synchronization device, and causes the Announce frame including the arbitration priority information (GM_PrB, GM_PrC, or GM_PrD) on the corresponding time-synchronization device to be retransmitted to the adjacent time-synchronization devices (100 to 400) (step S107).

After the Announce frame is transmitted, the GM selector 120 determines whether the value of the arbitration priority information (GM_PrA, GM_PrB, GM_PrC, or GM_PrD) included in the received Announce frame is the same as the values in the other time-synchronization devices and whether a GM is selected (step S108). When no GM is selected (No in step S108), the GM selector 120 returns to step S102 and repeats the processing in steps S102 to S108 until a GM is selected. When a GM is selected (Yes in step S108), the GM selection process at the startup of the system ends.

### Flowchart of GM Selection Process at Detachment of GM According to Present Embodiment

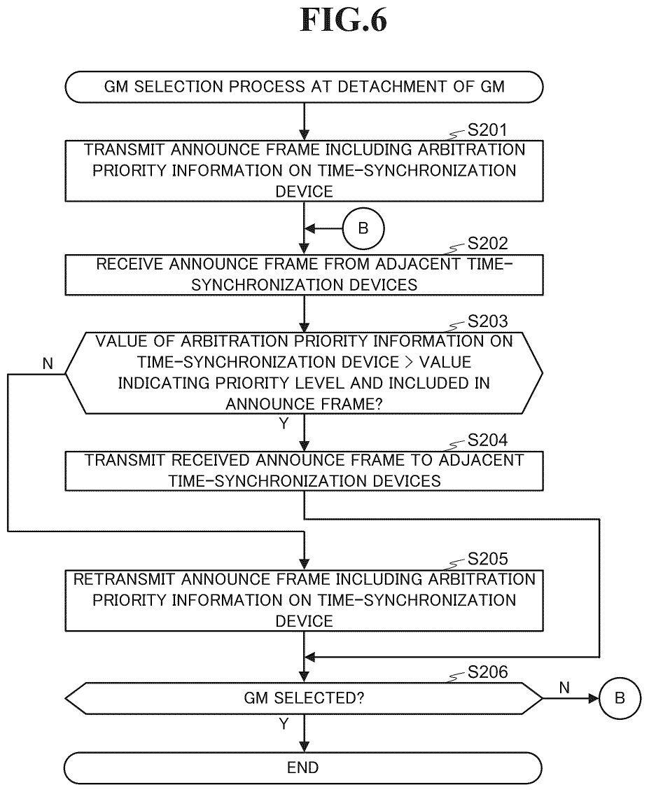

The operation of each of the time-synchronization devices 200 to 400 to select a new GM at detachment of the first time-synchronization device 100 that is the GM is now described with reference to the flowchart illustrated in FIG. 6. After a predetermined period from the last reception of a Sync frame from the first time-synchronization device 100, each of the time-synchronization devices 200 to 400 starts the GM selection process at detachment of the GM illustrated in FIG. 6. As illustrated in FIG. 6, the GM selector 120 first causes the information transmitter 160 to transmit an Announce frame including arbitration priority information (GM_PrB, GM_PrC, or GM_PrD) on the corresponding time-synchronization device to adjacent time-synchronization devices (200 to 400) (step S201) and causes the information receiver 170 to receive an Announce frame from the adjacent time-synchronization devices (200 to 400) (step S202).

After the Announce frame is received, the GM selector 120 determines whether the value of the arbitration priority information (GM_PrB, GM_PrC, or GM_PrD) on the corresponding time-synchronization device is greater than the value of the arbitration priority information (GM_PrC, GM_PrD, or GM_PrB) included in the received Announce frame (step S203). When the value of the arbitration priority information (GM_PrB, GM_PrC, or GM_PrD) on the corresponding time-synchronization device is greater than the value of the arbitration priority information included in the received Announce frame (Yes in step S203), the GM selector 120 determines that the corresponding time-synchronization device is a follower device, and causes the information transmitter 160 to transmit the received Announce frame to the adjacent time-synchronization devices (200 to 400) (step S204). When the value of the arbitration priority information (GM_PrB, GM_PrC, or GM_PrD) on the corresponding time-synchronization device is less than the value of the arbitration priority information (GM_PrC, GM_PrD, or GM_PrB) included in the received Announce frame (No in step S203), the GM selector 120 determines that the corresponding time-synchronization device may be a GM and causes the Announce frame including the arbitration priority information (GM_PrB, GM_PrC, or GM_PrD) on the corresponding time-synchronization device to be retransmitted to the adjacent time-synchronization devices (200 to 400) (step S205).

After the Announce frame is transmitted, the GM selector 120 determines whether the value of the arbitration priority information (GM_PrB, GM_PrC, or GM_PrD) included in the received Announce frame is the same as the values in the other time-synchronization devices and whether a GM is selected (step S206). When no GM is selected (No in step S206), the GM selector 120 returns to step S202 and repeats the processing in steps S202 to S206 until a GM is selected. When a GM is selected (Yes in step S206), the GM selection process at detachment of the GM ends.

### Flowchart of GM Selection Process at New Connection According to Present Embodiment

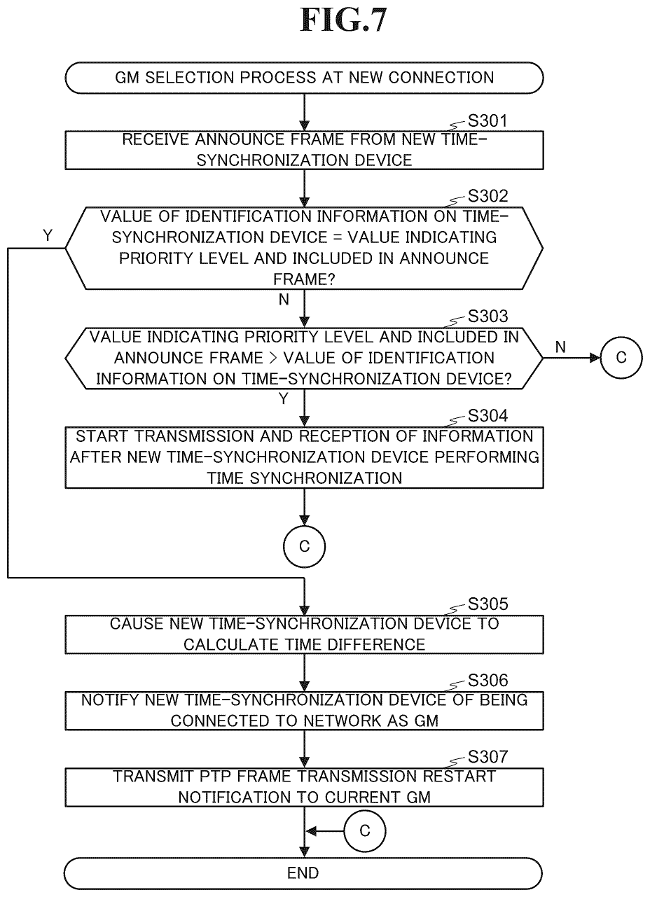

The operation to select a GM when a new time-synchronization device is connected to the network 500 while the second time-synchronization device 200 is performing time synchronization as a new GM is now described with reference to the flowchart illustrated in FIG. 7. When a new time-synchronization device is connected to the network 500 and transmits an Announce frame, the GM selection process at new connection illustrated in FIG. 7 starts. As illustrated in FIG. 7, the GM selector 120 first causes the information receiver 170 to receive an Announce frame from the new time-synchronization device (step S301), and then determines whether the value of the identification information included in the received Announce frame is the same as the value of the identification information (PrTM_B, PrTM_C, or PrTM_D) stored in the identification information storage 112 (step S302).

When the values of the identification information are not the same (No in step S302), the GM selector 120 determines that the new time-synchronization device is not the detached first time-synchronization device 100 and does not select the new time-synchronization device as a new GM. The network connection controller 150 determines whether the value of the identification information in the received Announcement frame is greater than the value of the stored identification information (PrTM_B, PrTM_C, or PrTM_D) (step S303). When the value of the identification information included in the received Announce frame is greater (Yes in step S303), the network connection controller 150 starts transmission and reception of information to and from the new time-synchronization device (step S304) after the new time-synchronization device performs time synchronization, and ends the GM selection process at new connection. When the value of the identification information included in the received Announce frame is smaller (No in step S303), the network connection controller 150 ends the GM selection process at new connection without starting transmission and reception of information to and from the new time-synchronization device.

When the values of the identification information are the same (Yes in step S302), the GM selector 120 determines that the new time-synchronization device is the detached first time-synchronization device 100. The time synchronizer 130 causes the information transmitter 160 and the information receiver 170 to transmit and receive the PTP frames such as Sync frames, Delay_req frames, and Delay_resp frames to cause the first time-synchronization device 100 to calculate a time difference (step S305). Thus, when the calculated time difference is greater than 30 seconds being an example of the threshold, the time synchronizer 130 in the first time-synchronization device 100 performs time synchronization to synchronize time with the second time-synchronization device 200 that is the current GM. After the time difference is calculated, the GM selector 120 selects the first time-synchronization device 100 that is the new time-synchronization device as a new GM. The GM selector 120 then notifies the first time-synchronization device 100 of being connected to the network 500 as a new GM (step S306), transmits a PTP frame transmission restart notification to the second time-synchronization device 200 that is the current GM (step S307), and ends the GM selection process at new connection.

As described above, in the time-synchronization system 1 according to the present embodiment, the GM selector 120 in each of the time-synchronization devices 100 to 400 on the network 500 performs the GM selection process at the startup of the system as an example of the GM arbitration process to select a GM. When selected as a GM, the time-synchronization device as a GM causes the time synchronizer 130 to perform time synchronization. When not selected as a GM, the time-synchronization device as a follower device causes the time synchronizer 130 to perform time synchronization. The identification information storage 112 stores identification information (PrTM_A, PrTM_B, PrTM_C, or PrTM_D) for identifying the first time-synchronization device 100 selected as the GM. When the first time-synchronization device 100 is disconnected and detached from the time-synchronization system 1, the GM selector 120 in each of the time-synchronization devices 200 to 400 performs the GM selection process at detachment of the GM as an example of the GM arbitration process and selects the second time-synchronization device 200 as a new GM. When a new time-synchronization device is connected to the time-synchronization system 1 and the GM selector 120 identifies, based on the identification information (PrTM_A, PrIM_B, PrTM_C, or PrTM_D), the new time-synchronization device as the detached first time-synchronization device 100, the GM selector 120 reselects the first time-synchronization device 100 as a GM without performing the GM arbitration process.

In the time-synchronization system 1 according to the present embodiment, as described above, when the new time-synchronization device connected to the network 500 is the first time-synchronization device 100 that is the returned previous GM, each of the time-synchronization devices 200 to 400 selects the first time-synchronization device 100 as the GM without performing the GM arbitration process. The first time-synchronization device 100 having the highest clock accuracy can then start time synchronization as the GM. The time-synchronization system 1 according to the present embodiment can thus switch to a GM with higher clock accuracy more promptly than the time-synchronization system in which the GM arbitration process is performed to reselect the returned previous GM. This reduces time-synchronization abnormalities resulting from the GM arbitration process using the BMCA.

In the time-synchronization system 1 according to the present embodiment, in particular, the values of the identification information (PrTM_A, PrTM_B, PrTM_C, and PrTM_D) are used to perform the GM arbitration process and indicate the priority level of the first time-synchronization device 100. The GM selector 120 in each of the time-synchronization devices 200 to 400 does not allow the identification information storage 112 to update the value of the identification information (PrTM_A, PrTM_B, PrTM_C, or PrTM_D) when the GM arbitration process is performed after the first time-synchronization device 100 is disconnected from the time-synchronization system 1 and the second time-synchronization device 200 is selected as a new GM. When a new time-synchronization device is connected to the time-synchronization system 1 and the priority level indicated in the identification information (PrTM_B, PrTM_C, or PrTM_D) stored in the identification information storage 112 is the same as the priority level indicated in the identification information acquired from the new time-synchronization device, the GM selector 120 selects the new time-synchronization device, or more specifically, the first time-synchronization device 100, as the GM.

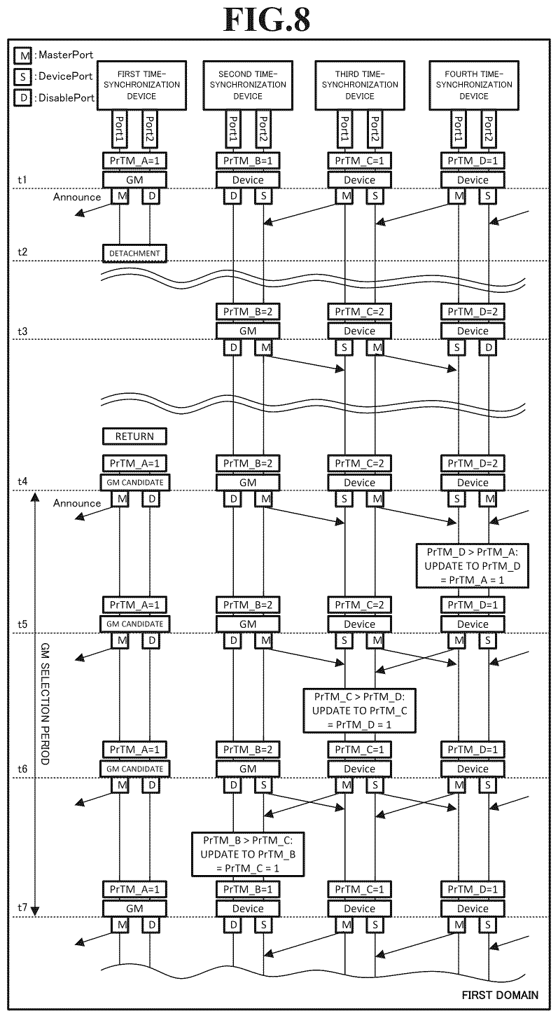

In a known time-synchronization system, control is performed when the first time-synchronization device that is a GM is disconnected and returned. As illustrated in FIG. 8, at a first timing t1 before detachment of the first time-synchronization device, the value of the identification information (PrTM_A, PrTM_B, PrTM_C, or PrTM_D) included in the Announce frame transmitted and received among the time-synchronization devices is 1 that is the same as the value of the identification information PrTM_A on the first time-synchronization device, or in other words, the value of the priority information PrA. Thus, PrTM_A=PrTM_B=PrTM_C=PrTM_D=PrA=1.

For example, in the first domain illustrated in FIG. 8, when an Announce frame including the identification information PrTM_A is transmitted from a first port that is a master port of the first time-synchronization device to a second port that is a device port of the fourth time-synchronization device in the GM arbitration process, the fourth time-synchronization device receives the Announce frame, compares the value 4 of the identification information PrTM_D stored in the fourth time-synchronization device with the value of the identification information PrTM_A, and updates the value of the identification information PrTM_D to 1. In the first domain, when an Announce frame including the identification information PrTM_D having the updated value 1 is transmitted from a first port that is a master port of the fourth time-synchronization device to a second port that is a device port of the third time-synchronization device, the third time-synchronization device receives the Announce frame, compares the value 3 of the identification information PrTM_C stored in the third time-synchronization device with the value of the identification information PrIM_D, and updates the value of the identification information PrTM_C to 1. In the first domain, when an Announce frame including the identification information PrTM_C having the updated value 1 is transmitted from a first port that is a master port of the third time-synchronization device to a second port that is a device port of the second time-synchronization device, the second time-synchronization device receives the Announce frame, compares the value 2 of the identification information PrTM_B stored in the second time-synchronization device with the value of the identification information PrTM_C, and updates the value of the identification information PrTM_B to 1. The second domain is the same as the first domain described above by replacing the second time-synchronization device with the fourth time-synchronization device, replacing the fourth time-synchronization device with the second time-synchronization device, replacing the first port with the second port, and replacing the second port with the first port. The example with these components is thus not illustrated or described in detail to avoid redundancy.

At a second timing t2 at which the first time-synchronization device is detached, each time-synchronization device connected to the network restarts selection of a new GM in the GM arbitration process. Each time-synchronization device transmits and receives an Announce frame including the priority information (PrB, PrC, or PrD) on the corresponding time-synchronization device to and from adjacent time-synchronization devices and repeatedly compares the values of the priority information (PrB, PrC, and PrD) to select the second time-synchronization device having the minimum value 2 as a new GM. Each time-synchronization device updates the value of the identification information (PrTM_B, PrTM_C, or PrTM_D) stored in the corresponding time-synchronization device to the value 2 that is the same as the value of the priority information PrB on the second time-synchronization device. Thus, the value of the identification information PrTM_B, PrTM_C, or PrTM_D on each time-synchronization device is PrTM_B=PrTM_C=PrTM_D=PrB=2.

At a third timing t3 after a new GM is selected, the third time-synchronization device and the fourth time-synchronization device as follower devices perform time synchronization with the second time-synchronization device that is the new GM. For example, in the first domain illustrated in FIG. 8, frames for time synchronization are transmitted and received between the second port that is the master port of the second time-synchronization device and the first port that is the device port of the third time-synchronization device to synchronize time of the third time-synchronization device with the time of the second time-synchronization device that is the new GM. In the first domain, frames for time synchronization are transmitted and received between the second port that is the master port of the third time-synchronization device and the first port that is the device port of the fourth time-synchronization device to synchronize time of the fourth time-synchronization device with the time of the third time-synchronization device, allowing the time of the fourth time-synchronization device to synchronize with the time of the second time-synchronization device that is the new GM. The second domain is the same as the first domain described above by replacing the third time-synchronization with the fourth time-synchronization device, replacing the fourth time-synchronization device with the third time-synchronization device, replacing the first port with the second port, and replacing the second port with the first port. The example with these components is thus not illustrated or described in detail to avoid redundancy.

At a fourth timing t4 at which the first time-synchronization device returns, each time-synchronization device including the first time-synchronization device starts selection of a new GM in the GM arbitration process. More specifically, the first time-synchronization device transmits and receives an Announce frame including the identification information PrTM_A on the first time-synchronization device to and from adjacent time-synchronization devices and repeatedly compares the values of the identification information (PrTM_A, PrTM_B, PrTM_C, and PrTM_D) to select the first time-synchronization device having the minimum value 1 as a new GM. Each time-synchronization device updates the value of the identification information (PrTM_B, PrTM_C, or PrTM_D) stored in the corresponding time-synchronization device to the same value as the priority information PrTM_A on the first time-synchronization device, or in other words, as the priority information PrA. Thus, the value of the identification information PrTM_A, PrTM_B, PrTM_C, or PrTM_D on each of the time-synchronization devices including the first time-synchronization device returns to PrTM_A=PrTM_B=PrTM_C=PrTM_D=PrA=1.

In the first domain illustrated in FIG. 8, for example, when an Announce frame including the identification information PrTM_A is transmitted from the first port that is the master port of the first time-synchronization device to the second port that is the master port of the fourth time-synchronization device, the fourth time-synchronization device receives the Announce frame, compares the value 2 of the identification information PrTM_D stored in the fourth time-synchronization device with the value of the identification information PrTM_A, and updates the value of the identification information PrTM_D to 1. The fourth time-synchronization device changes the first port from the device port to the master port and the second port from the master port to the device port. In the first domain, at a fifth timing t5 after the ports of the fourth time-synchronization device are changed, when an Announce frame including the identification information PrTM_D having the updated value 1 is transmitted from the first port that is the master port of the fourth time-synchronization device to the second port that is the master port of the third time-synchronization device, the third time-synchronization device receives the Announce frame, compares the value 2 of the identification information PrTM_C stored in the third time-synchronization device with the value of the identification information PrTM_D, and updates the value of the identification information PrTM_C to 1. The third time-synchronization device changes the first port from the device port to the master port and the second port from the master port to the device port.

In the first domain, at a sixth timing to after the ports of the third time-synchronization device are changed, when an Announce frame including the identification information PrTM_C having the updated value 1 is transmitted from the first port that is the master port of the third time-synchronization device to the second port that is the master port of the second time-synchronization device, the second time-synchronization device receives the Announce frame, compares the value 2 of the identification information PrTM_B stored in the second time-synchronization device with the value of the identification information PrTM_C, and updates the value of the identification information PrTM_B to 1. The second time-synchronization device changes the first port from the device port to the master port and the second port from the master port to the device port. In a period before the first time-synchronization device is selected as a new GM, or more specifically, in a period between the third timing t3 and a seventh timing t7 at which the ports of the second time-synchronization device are changed, each time-synchronization device does not perform time synchronization when receiving a frame for time synchronization from an adjacent time-synchronization device. The second domain is the same as the first domain described above by replacing the second time-synchronization device with the fourth time-synchronization device, replacing the fourth time-synchronization device with the second time-synchronization device, replacing the first port with the second port, and replacing the second port with the first port. The example with these components is thus not illustrated or described in detail to avoid redundancy.

In a known time-synchronization system, when the first time-synchronization device that is a detached GM returns, the first time-synchronization device may be reselected as a new GM in the GM arbitration process. Thus, the other time-synchronization devices cannot perform time synchronization until the GM is switched from the second time-synchronization device 200 that is the current GM to the first time-synchronization device 100 that is the new GM, possibly causing a time-synchronization abnormality.

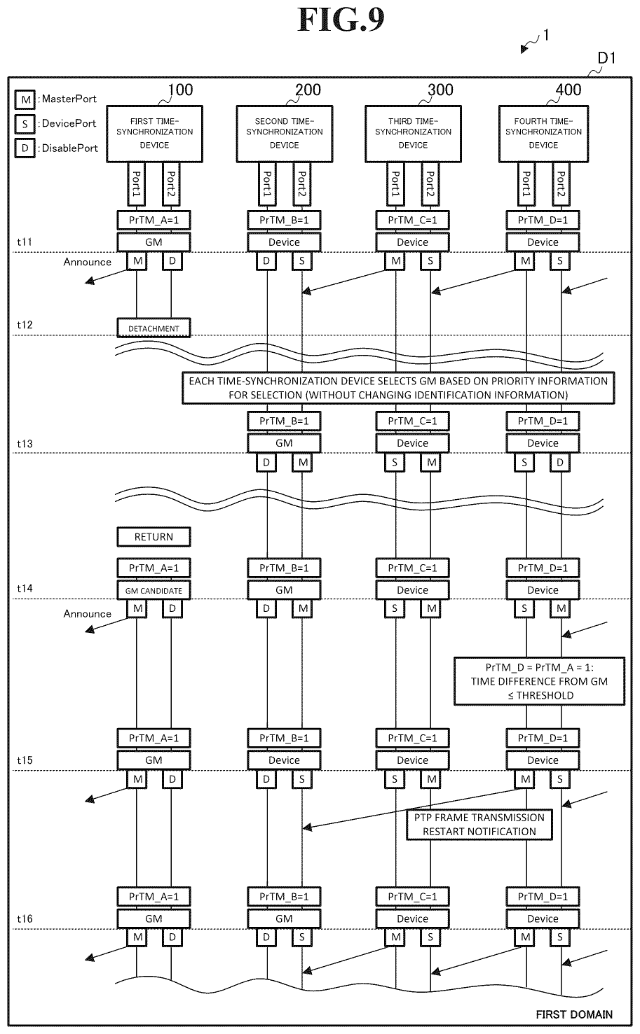

In the time-synchronization system 1 according to the present embodiment, as illustrated in FIG. 9, the time-synchronization devices 100 to 400 each transmit and receive an Announce frame at an eleventh timing t11 before the first time-synchronization device 100 is detached, similarly to the time-synchronization devices 100 to 400 at the first timing t1 in the known time-synchronization system. In the time-synchronization system 1 according to the present embodiment, the time-synchronization devices 200 to 400 each restarts selection of a new GM in the GM arbitration process at a twelfth timing t12 at which the first time-synchronization device 100 is detached, similarly to the time-synchronization devices 200 to 400 at the second timing t2 in the known time-synchronization system.

In the time-synchronization system 1 according to the present embodiment, at a thirteenth timing t13 at which the second time-synchronization device 200 is selected as a new GM, each of the time-synchronization devices 200 to 400 does not update the value of the identification information (PrTM_B, PrTM_C, or PrTM_D) stored in the corresponding time-synchronization device to the value 2 that is the same value as the priority information PrB on the second time-synchronization device 200. Thus, the value of the identification information (PrTM_B, PrIM_C, or PrTM_D) remains PrIM_B=PrTM_C=PrTM_D=PrA=1.

In the time-synchronization system 1 according to the present embodiment, at a fourteenth timing t14 at which the time-synchronization device 100 returns, the first time-synchronization device 100 transmits an Announce frame including the identification information PrTM_A to the adjacent time-synchronization devices, and the other time-synchronization devices 200 to 400 each confirm that the value of the identification information (PrTM_B, PrIM_C, or PrTM_D) stored in the respective time-synchronization devices 200 to 400 is the same as the value of the identification information PrTM_A included in the received Announce frame. The time-synchronization device 100 is thus reselected as a new GM.

For example, in a first domain D1 illustrated in FIG. 9, when an Announce frame including the identification information PrTM_A is transmitted from the first port that is a master port of the first time-synchronization device 100 to the second port that is the master port of the fourth time-synchronization device 400 in the GM arbitration process, the fourth time-synchronization device 400 receives the Announce frame, compares the value 1 of the identification information PrTM_D stored in the fourth time-synchronization device 400 with the value of the identification information PrTM_A, and determines that the values are the same. In the first domain D1, when the time difference between the time of the first time-synchronization device 100 and the time of the second time-synchronization device 200 that is the current GM is less than or equal to 30 seconds being an example of the threshold, the fourth time-synchronization device 400 determines, at a fifteenth timing, that the first time-synchronization device 100 is the detached previous GM and notifies the first time-synchronization device 100 of being connected to the network 500 as a new GM and transmits a PTP frame transmission restart notification to the second time-synchronization device 200. At a sixteenth timing in the first domain D1, the time-synchronization devices 100 to 400 are each in the same state as at the eleventh timing t11, and the first time-synchronization device 100 returns to the network 500 and performs time synchronization as a new GM. The second domain D2 is the same as the first domain D1 described above by replacing the second time-synchronization device with the fourth time-synchronization device, replacing the fourth time-synchronization device with the second time-synchronization device, replacing the first port with the second port, and replacing the second port with the first port. The example with these components is thus not illustrated or described in detail to avoid redundancy.

In the time-synchronization system 1 according to the present embodiment, when the first time-synchronization device 100 that is the detached GM returns, the first time-synchronization device 100 is reselected as a new GM without the GM arbitration process. Thus, the time-synchronization system 1 according to the present embodiment allows the other time-synchronization devices 300 and 400 to perform time synchronization with the second time-synchronization device 200 before the GM is switched from the second time-synchronization device 200 that is the current GM to the first time-synchronization device 100 that is the new GM. The time-synchronization system 1 according to the present embodiment can thus reduce time-synchronization abnormalities more than a known time-synchronization system.

In the time-synchronization system 1 according to the present embodiment, when a new time-synchronization device is connected to the time-synchronization system 1, each of the time-synchronization devices 200 to 400 causes the time difference calculator 140 to compare the time of the second time-synchronization device 200 that is the current GM with the time of the new time-synchronization device to calculate a time difference.

In the time-synchronization system 1 according to the present embodiment, as described above, the time-synchronization devices 200 to 400 can determine the time difference between the time of the second time-synchronization device 200 that is the current GM and the time of the new time-synchronization device.

In the time-synchronization system 1 according to the present embodiment, in particular, when the new time-synchronization device is the detached first time-synchronization device 100 and the calculated time difference is less than or equal to 30 seconds being an example of the predetermined threshold, the new time-synchronization device performs time synchronization as a new GM without performing time synchronization with the second time-synchronization device 200 that is the current GM. Thus, when the new time-synchronization device is the detached first time-synchronization device 100, each of the time-synchronization devices 200 to 400 as a follower device causes the time synchronizer 130 to perform time synchronization with the new time-synchronization device, or in other words, the first time-synchronization device 100 that has not performed time synchronization after being connected to the time-synchronization system 1.

In the time-synchronization system 1 according to the present embodiment, as described above, when the time difference between the time of the first time-synchronization device 100 and the time of the second time-synchronization device 200 that is the current GM is less than the threshold, the first time-synchronization device 100 can start time synchronization as a new GM without performing time synchronization with the current GM. Thus, the period before a new GM starts time synchronization in the time-synchronization system 1 according to the present embodiment is shorter than in a time-synchronization system that synchronizes the time of the current GM with the time of the new GM independently of the time difference.

In the time-synchronization system 1 according to the present embodiment, when the new time-synchronization device is the detached first time-synchronization device 100 and the calculated time difference is greater than 30 seconds being an example of the predetermined threshold, the new time-synchronization device performs time synchronization as a new GM after performing time synchronization with the second time-synchronization device 200 that is the current GM. Thus, when the new time-synchronization device is the detached first time-synchronization device 100, each of the time-synchronization devices 200 to 400 as a follower device causes the time synchronizer 130 to perform time synchronization with the new time-synchronization device, or in other words, the first time-synchronization device 100 that has performed time synchronization after being connected to the time-synchronization system 1.

In the time-synchronization system 1 according to the present embodiment, as described above, when the time difference between the time of the first time-synchronization device 100 and the time of the second time-synchronization device 200 that is the current GM is greater than the threshold, the first time-synchronization device 100 can start time synchronization as a new GM after synchronizing time with the second time-synchronization device 200. Thus, the time-synchronization system 1 according to the present embodiment can reduce time-synchronization abnormalities more than a time-synchronization system that does not synchronize the time of the current GM with the time of the new GM when the time difference is greater than the threshold.

In the time-synchronization system 1 according to the present embodiment, when a new time-synchronization device is connected to the time-synchronization system 1 and the priority level indicated in the identification information (PrIM_B, PrTM_C, or PrTM_D) stored in the identification information storage 112 is higher than the priority level indicated in the identification information acquired from the new time-synchronization device, the GM selector 120 in each of the time-synchronization devices 200 to 400 does not select a new GM. In this case, the new time-synchronization device that is not the detached first time-synchronization device 100 is enabled to transmit and receive information to and from the time-synchronization devices (200 to 400) after performing time synchronization with the second time-synchronization device 200 that is the current GM.

In the time-synchronization system 1 according to the present embodiment, as described above, the new time-synchronization device can start transmission and reception of information as a new follower device to and from the other time-synchronization devices after synchronizing the time of the new time-synchronization device with the time of the second time-synchronization device 200 that is the current GM. Thus, the time-synchronization system 1 according to the present embodiment can reduce time-synchronization abnormalities more than a time-synchronization system in which a new time-synchronization device starts transmission and reception of information to and from the other time-synchronization devices without synchronizing time of the current GM with the time of the new time-synchronization device that is to be a follower device.

In the time-synchronization system 1 according to the present embodiment, when a new time-synchronization device is connected to the time-synchronization system 1 and the priority level indicated in the identification information (PrTM_B, PrTM_C, or PrIM_D) stored in the identification information storage 112 is lower than the priority level indicated in the identification information acquired from the new time-synchronization device, the GM selector 120 in each of the time-synchronization devices 200 to 400 does not select a new GM. In this case, the new time-synchronization device is disconnected from the time-synchronization system 1.

In the time-synchronization system 1 according to the present embodiment, as described above, the new time-synchronization device that is not the detached first time-synchronization device 100 performs time synchronization as a new GM, thus preventing time-synchronization abnormalities.

### Modifications

In the present embodiment, the value of the identification information PrTM_A, PrTM_B, PrTM_C, or PrTM Dis I that is the value of the priority information PrA on the first time-synchronization device 100 selected as the GM, or in other words, the value indicating the priority level of the first time-synchronization device 100. However, the value may be any value for identifying the first time-synchronization device 100. For example, the value of the identification information PrTM_A, PrTM_B, PrTM_C, or PrTM_D may be a value indicating the station number, a value indicating the IP address, or a value indicating the clock ID of the first time-synchronization device 100 selected as the GM.

As in the present embodiment, when the time difference between the time of the first time-synchronization device 100 that is the returned previous GM and the time of the second time-synchronization device 200 that is the current GM is less than the threshold, the first time-synchronization device 100 may start time synchronization as a new GM without performing time synchronization with the current GM. However, the first time-synchronization device 100 may start time synchronization after performing time synchronization with the current GM independently of the time difference.

As in the present embodiment, when the priority level indicated in the identification information (PrTM_B, PrTM_C, or PrTM_D) stored in the corresponding time-synchronization device is lower than the priority level indicated in the identification information acquired from the new time-synchronization device connected to the time-synchronization system 1, each of the time-synchronization devices 200 to 400 may perform control for not selecting a new GM. However, the time-synchronization devices 200 to 400 may perform the GM arbitration process using the BMCA to select a new GM.

In this case, when the priority level of the new time-synchronization device is higher than the priority level of the second time-synchronization device 200 that is the current GM, the new time-synchronization device is selected as the new GM. When the new time-synchronization device is selected as the new GM, as with the first time-synchronization device 100 that is the returned previous GM being reselected as a new GM, and the time difference between the time of the new time-synchronization device and the time of the second time-synchronization device 200 that is the current GM is greater than the threshold, the new time-synchronization device may start time synchronization as a new GM after synchronizing time with the second time-synchronization device 200.

In this case, when the priority level of the new time-synchronization device is lower than the priority level of the second time-synchronization device 200 that is the current GM, the new time-synchronization device is to be a new follower device instead of being selected as a new GM. When the new time-synchronization device is to be a new follower device, as in the present embodiment, the new time-synchronization device may be enabled to transmit and receive information to and from the time-synchronization devices (200 to 400) after performing time synchronization with the second time-synchronization device 200 that is the current GM.

The main operating portions of the first time-synchronization device 100, the second time-synchronization device 200, the third time-synchronization device 300, and the fourth time-synchronization device 400 each including the controller 51, the main storage 52, the external storage 53, the operation device 54, the display 55, and the transmitter-receiver 56 connected to one another with the internal bus 50 can be implemented by a common computer system instead of a dedicated system. For example, a computer program for performing the above operation may be stored in a non-transitory computer-readable recording medium, such as a flash memory or a digital versatile disc read-only memory (DVD-ROM), distributed, and installed in a computer to implement the first time-synchronization device 100, the second time-synchronization device 200, the third time-synchronization device 300, and the fourth time-synchronization device 400 that perform the above processes. The computer program may be stored in a storage device in a server on a communication network such as the Internet, and downloaded to a common computer system to implement the first time-synchronization device 100, the second time-synchronization device 200, the third time-synchronization device 300, and the fourth time-synchronization device 400.

When the functions of the first time-synchronization device 100, the second time-synchronization device 200, the third time-synchronization device 300, and the fourth time-synchronization device 400 are implemented partially by an operating system (OS) and partially by an application program, or through cooperation between the OS and the application program, portions of the application program alone may be stored in a non-transitory recording medium or a storage device.

Also, the computer program may be superimposed on a carrier wave to be provided with a communication network. For example, the computer program may be posted on a bulletin board system (BBS) on a communication network to be provided through the network. The above processes may be performed by launching the computer program and executing the computer program under control by the OS in the same manner as in another application program.

The foregoing describes some example embodiments for explanatory purposes. Although the foregoing discussion has presented specific embodiments, persons skilled in the art will recognize that changes may be made in form and detail without departing from the broader spirit and scope of the invention. Accordingly, the specification and drawings are to be regarded in an illustrative rather than a restrictive sense. This detailed description, therefore, is not to be taken in a limiting sense, and the scope of the invention is defined only by the included claims, along with the full range of equivalents to which such claims are entitled.

### REFERENCE SIGNS LIST

1 Time-synchronization system
50 Internal bus
51 Controller
52 Main storage
53 External storage
54 Operation device
55 Display
56 Transmitter-receiver
59 Control program
100 First time-synchronization device
110 Information storage
111 Priority information storage
112 Identification information storage
113 Arbitration priority information storage
120 GM selector
130 Time synchronizer
140 Time difference calculator
150 Network connection controller
160 Information transmitter
170 Information receiver
200 Second time-synchronization device
300 Third time-synchronization device
400 Fourth time-synchronization device
500 Network

1. A time-synchronization device for performing time synchronization as a grandmaster or a follower device in a time-synchronization system, the time-synchronization device comprising:
processing circuitry;
a storage; and
a transmitter-receiver, wherein
the processing circuitry selects the grandmaster by performing a grandmaster arbitration process for identifying, from a plurality of time-synchronization devices included in the time-synchronization system, one time-synchronization device corresponding to the grandmaster,
the processing circuitry performs time synchronization as the grandmaster when the time-synchronization device is selected as the grandmaster and performs time synchronization as the follower device when the time-synchronization device is not selected as the grandmaster,
the storage stores identification information for identifying the one time-synchronization device selected as the grandmaster,
when the one time-synchronization device is disconnected and detached from the time-synchronization system, the processing circuitry selects the grandmaster from the plurality of time-synchronization devices excluding the one time-synchronization device by performing the grandmaster arbitration process, and
when a new time-synchronization device is connected to the time-synchronization system and the processing circuitry identifies the new time-synchronization device as the detached one time-synchronization device based on the identification information, the processing circuitry selects the new time-synchronization device as the grandmaster without performing the grandmaster arbitration process.

2. The time-synchronization device according to claim 1, wherein
the identification information is used to perform the grandmaster arbitration process and indicates a priority level of the one time-synchronization device,
the storage does not update the identification information when the one time-synchronization device is detached from the time-synchronization system and the grandmaster is selected from the plurality of time-synchronization devices excluding the one time-synchronization device in the grandmaster arbitration process, and
when a new time-synchronization device is connected to the time-synchronization system and a priority level indicated in the identification information stored in the storage is same as a priority level indicated in the identification information acquired from the new time-synchronization device, the processing circuitry selects the new time-synchronization device as the grandmaster.

3. The time-synchronization device according to claim 1, wherein
the processing circuitry compares, when a new time-synchronization device is connected to the time-synchronization system, a time of a current grandmaster with a time of the new time-synchronization device to calculate a time difference.

4. The time-synchronization device according to claim 3, wherein
when the new time-synchronization device is the detached one time-synchronization device and the calculated time difference is less than or equal to a predetermined threshold, the new time-synchronization device performs time synchronization as a new grandmaster without performing time synchronization with the current grandmaster, and
when the new time-synchronization device is the detached one time-synchronization device, the processing circuitry in the time-synchronization device being the follower device performs time synchronization with the new time-synchronization device that has not performed time synchronization after being connected to the time-synchronization system.

5. The time-synchronization device according to claim 3, wherein
when the new time-synchronization device is the detached one time-synchronization device and the calculated time difference is greater than a predetermined threshold, the new time-synchronization device performs time synchronization as a new grandmaster after performing time synchronization with the current grandmaster, and
when the new time-synchronization device is the detached one time-synchronization device, the processing circuitry in the time-synchronization device being the follower device performs time synchronization with the new time-synchronization device that has performed time synchronization after being connected to the time-synchronization system.

6. The time-synchronization device according to claim 2, wherein
the processing circuitry selects no new grandmaster when the priority level indicated in the identification information stored in the storage is different from the priority level indicated in the identification information acquired from the new time-synchronization device, and
when the priority level indicated in the identification information stored in the new time-synchronization device is lower than a priority level indicated in the identification information stored in another time-synchronization device included in the time-synchronization system, the new time-synchronization device is enabled to transmit and receive information to and from the other time-synchronization device after performing time synchronization with the grandmaster.

7. The time-synchronization device according to claim 2, wherein
the processing circuitry selects no new grandmaster when the priority level indicated in the identification information stored in the storage is different from the priority level indicated in the identification information acquired from the new time-synchronization device, and
when the priority level indicated in the identification information stored in the new time-synchronization device is higher than a priority level indicated in the identification information stored in another time-synchronization device included in the time-synchronization system, the new time-synchronization device is disconnected from the time-synchronization system.

8. A time-synchronization system, comprising:
a plurality of time-synchronization devices each to perform time synchronization as a grandmaster or a follower device,
wherein any time-synchronization device of the plurality of time-synchronization devices includes processing circuitry, a storage, and a transmitter-receiver,
the processing circuitry of the time-synchronization device selects the grandmaster by performing a grandmaster arbitration process for identifying, from the plurality of time-synchronization devices, one time-synchronization device corresponding to the grandmaster,
the processing circuitry of the time-synchronization device performs time synchronization as the grandmaster when the time-synchronization device is selected as the grandmaster and performs time synchronization as the follower device when the time-synchronization device is not selected as the grandmaster, and
the storage of the time-synchronization device stores identification information for identifying the one time-synchronization device selected as the grandmaster,
when the one time-synchronization device is disconnected and detached from the time-synchronization system, the processing circuitry of the time-synchronization device selects the grandmaster from the plurality of time-synchronization devices excluding the one time-synchronization device by performing the grandmaster arbitration process, and
when a new time-synchronization device is connected to the time-synchronization system and the processing circuitry of the time-synchronization device identifies the new time-synchronization device as the detached one time-synchronization device based on the identification information, the processing circuitry of the time-synchronization device selects the new time-synchronization device as the grandmaster without performing the grandmaster arbitration process.

9. (canceled)

10. A program for causing a computer to perform operations comprising:
selecting a grandmaster of a time-synchronization system by performing a grandmaster arbitration process for identifying, from a plurality of computers included in the time-synchronization system, one computer corresponding to the grandmaster of the time-synchronization system;
performing time synchronization as the grandmaster when the computer is selected as the grandmaster, and to perform time synchronization as a follower device of the time-synchronization system when the computer is not selected as the grandmaster; and
storing identification information for identifying the one computer selected as the grandmaster,
wherein the program further causes the computer to perform operations comprising
selecting, when the one computer is disconnected and detached from the time-synchronization system, the grandmaster from the plurality of computers excluding the one computer by performing the grandmaster arbitration process, and
selecting, when a new computer is connected to the time-synchronization system and the new computer is identified as the detached one computer based on the identification information, the new computer as the grandmaster without performing the grandmaster arbitration process.

11. The time-synchronization device according to claim 2, wherein
the processing circuitry compares, when a new time-synchronization device is connected to the time-synchronization system, a time of a current grandmaster with a time of the new time-synchronization device to calculate a time difference.
